(19) United States
(12) Patent Application Publication
(10) Pub. No.: US 2018/0137732 A1
(43) Pub. Date: May 17, 2018

(54) USER LOCATION NOTIFICATION SYSTEM AND METHOD THEREOF

(71) Applicant: Aengin Technology Inc., Taipei City (TW)

(72) Inventors: Kai-Chieh Yang, Taipei City (TW); Yi-Hsiang Chen, Taipei City (TW); Yi-Hsuang Chen, Taipei City (TW); Ning-Chain Hsu, Taipei City (TW)

(73) Assignee: Aengin Technology Inc., Taipei City (TW)

(21) Appl. No.: 15/794,007

(22) Filed: Oct. 26, 2017

Related U.S. Application Data
(60) Provisional application No. 62/423,161, filed on Nov. 16, 2016.

(30) Foreign Application Priority Data
Jun. 28, 2017 (TW) 106121664

(51) Int. Cl. G08B 21/02

(52) U.S. Cl. CPC G08B 21/0272; G08B 21/0222; G08B 21/0277

(57) ABSTRACT

A user location notification system and a method thereof are provided. The system includes a first signal transmitting device, a first sensing device and a server. The first signal transmitting device transmits a first signal associated with a first user. The first sensing device detects the first signal and transmits a first message according to the first signal. The first sensing device is deployed at a first place. The server receives the first message and transmits a first notification message to a first electronic device according to the first message. The first notification message indicates that the first user is located in a first range adjacent to the first place.

### CROSS-REFERENCE TO RELATED APPLICATION

This application claims the priority benefits of U.S. provisional application Ser. No. 62/423,161, filed on Nov. 16, 2016 and Taiwan application serial no. 106121664, filed on Jun. 28, 2017. The entirety of each of the above-mentioned patent applications is hereby incorporated by reference herein and made a part of this specification.

### BACKGROUND OF THE INVENTION

### 1. Field of the Invention

The invention relates to a user location notification system and a method thereof.

### 2. Description of Related Art

In general, when children are off to school, parents are unable to specifically learn the current locations of their children. In addition, since there are normally a plurality of classrooms and locations in one school, teachers are unable to specifically and quickly learn whereabouts of the students and the number of people in the classroom.

### SUMMARY OF THE INVENTION

Accordingly, the invention provides a user location notification system and a method thereof. The system allows parents and teachers to conveniently learn current locations and whereabouts of monitored students in a real-time manner.

An embodiment of the invention provides a user location notification system. The system includes a first signal transmitting device, a first sensing device and a server. The first signal transmitting device transmits a first signal associated with a first user. The first sensing device detects the first signal and transmits a first message according to the first signal. The first sensing device is deployed at a first place. The server receives the first message and transmits a first notification message to a first electronic device according to the first message. The first notification message indicates that the first user is located in a first range adjacent to the first place.

An embodiment of the invention provides a user location notification method. The method includes: transmitting a first signal associated with a first user by a first signal transmitting device; detecting the first signal and transmitting a first message according to the first signal by a first sensing device, wherein the first sensing device is deployed at a first place; and receiving the first message and transmitting a first notification message to a first electronic device according to the first message by a server, wherein the first notification message indicates that the first user is in a first range adjacent to the first place.

Based on the above, the user location notification system according to the embodiments of the invention allows the parents and the teachers to conveniently learn the current locations and whereabouts of the monitored students in a real-time manner, thereby checking the attendance. Hence, the efficiency of personnel management is reinforced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a user location notification system according to an embodiment of the invention.

FIG. 2A is a schematic view illustrating an electronic device according to an embodiment of the invention.

FIG. 2B is a schematic view illustrating a server according to an embodiment of the invention.

FIG. 2C is a schematic view illustrating a signal transmitting device according to an embodiment of the invention.

FIG. 2D is a schematic view illustrating a sensing device according to an embodiment of the invention.

FIGS. 3A to 3C are schematic views illustrating a scenario of using a user location notification system according to an embodiment of the invention.

FIG. 4 is a flowchart illustrating a user location notification method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

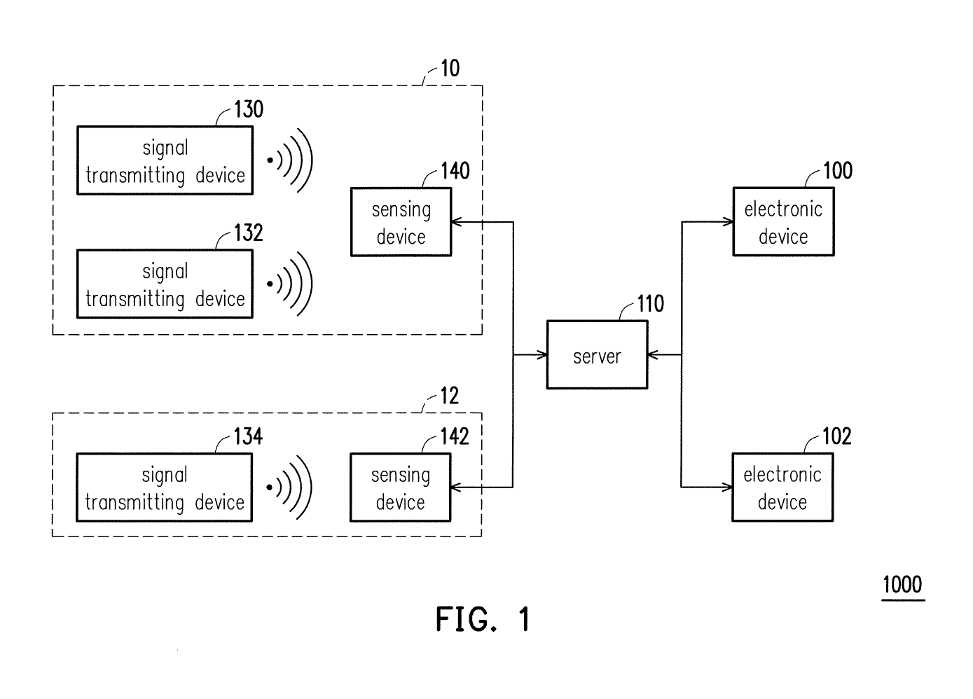

FIG. 1 is a schematic view illustrating a user location notification system according to an embodiment of the invention.

Referring to FIG. 1, in the exemplary embodiment, a user location notification system 1000 includes an electronic device 100, an electronic device 102, a server 110, a signal transmitting device 130, a signal transmitting device 132, a signal transmitting device 134, a sensing device 140, and a sensing device 142. In addition, the electronic device 100, the electronic device 102, and the server 110 may communicate via a wired or wireless network. The sensing device 140, the sensing device 142, and the server 110 may communicate via a wired or wireless network. Moreover, the sensing device 140 is deployed at a place 10 and detects signals transmitted by the signal transmitting device 130 and the signal transmitting device 132 in a range adjacent to the place 10. Similarly, the sensing device 142 is deployed at a place 12 and detects a signal transmitted by the signal transmitting device 134 in a range adjacent to the place 12. The place 10 and the place 12 are, for example, a classroom, a school gate, an office, or other places suitable to deploy the sensing device 140 and the sensing device 142.

It should be noted that the invention does not intend to limit the numbers of the electronic device, the server, the sensing device, the signal transmitting device, and the place deploying the sensing device in the user location notification system 1000. In addition, while FIG. 1 illustrates that one sensing device is deployed at one place, a plurality of sensing devices may also be deployed at one place in other embodiments.

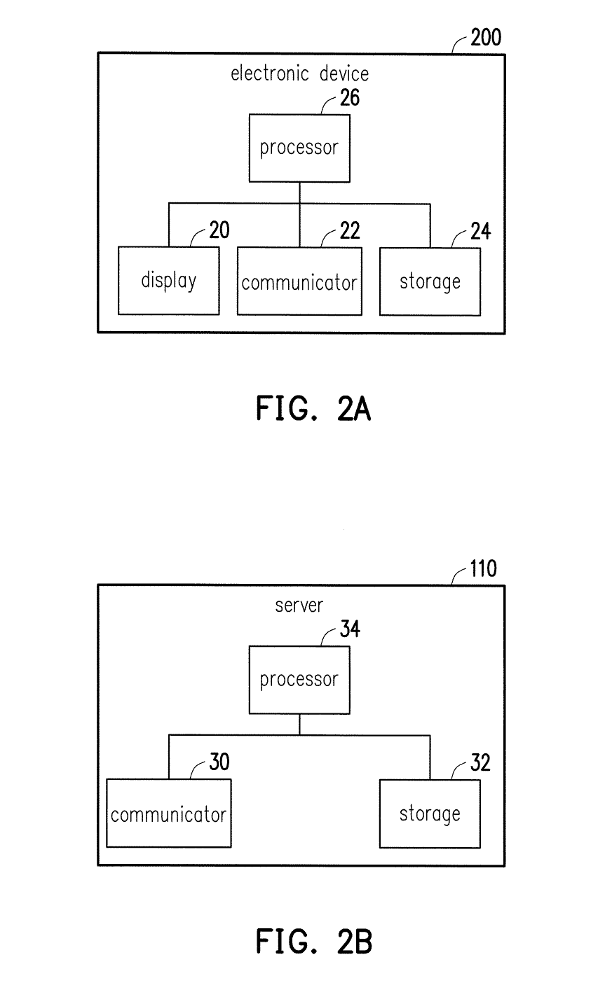

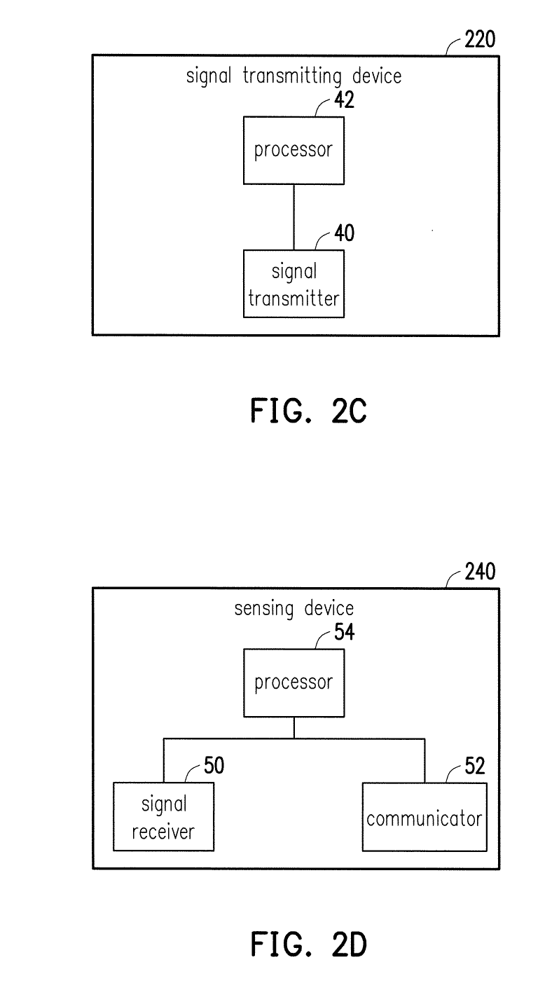

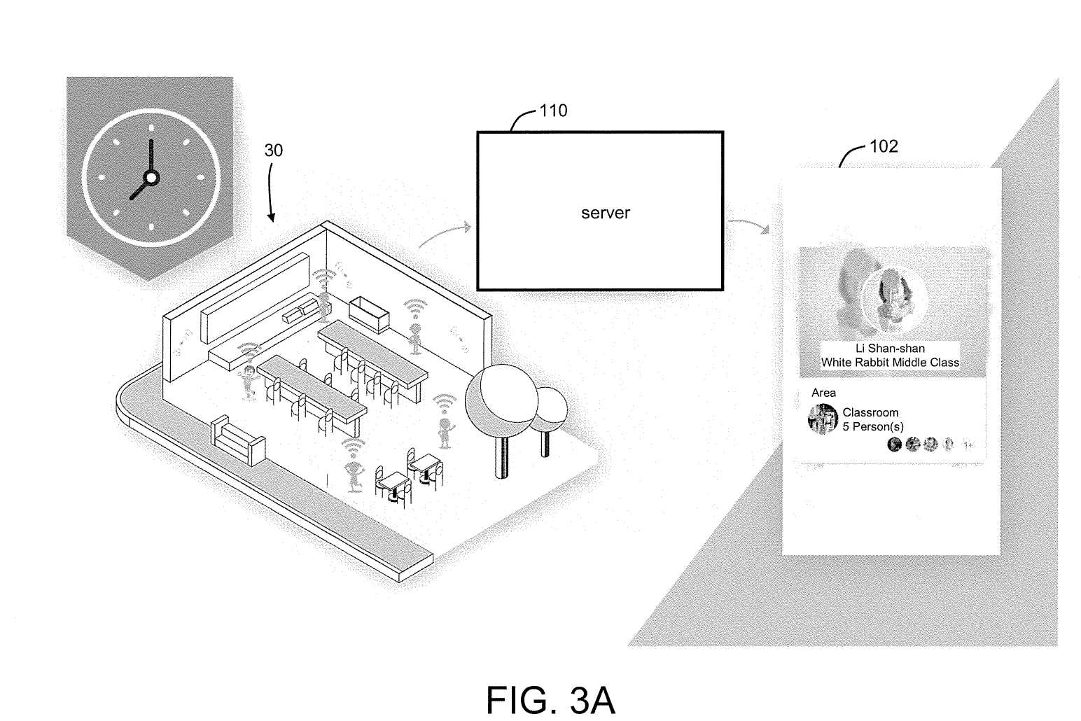

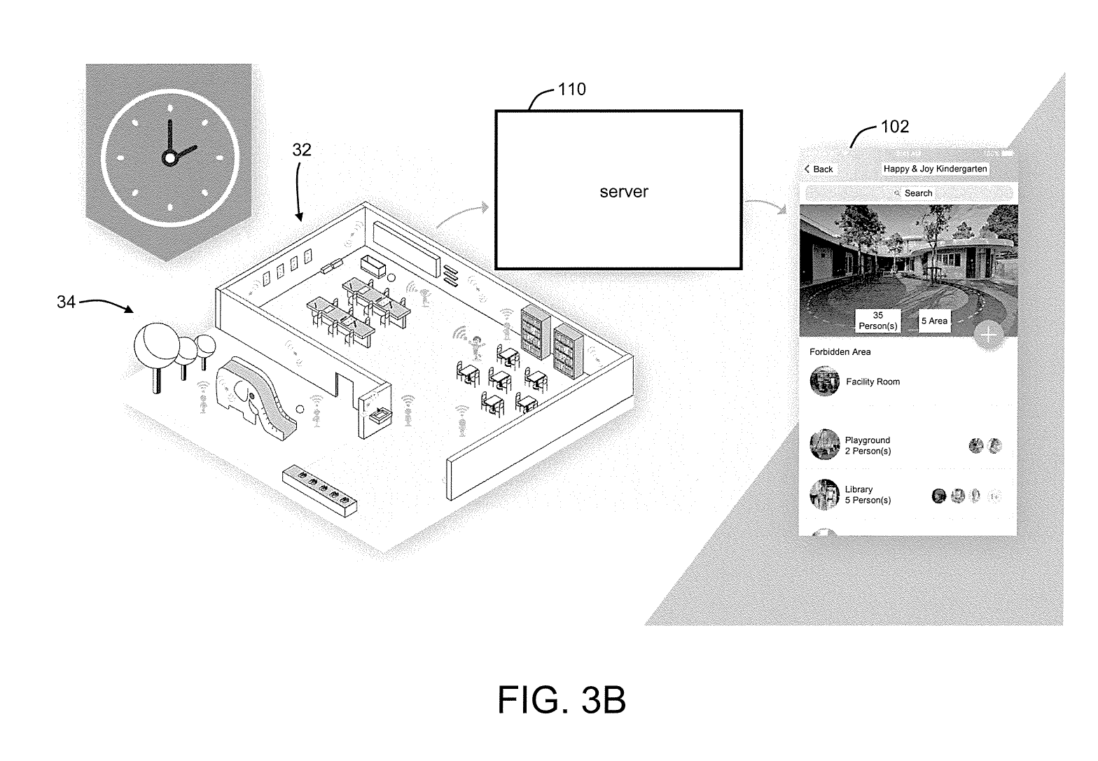

FIG. 2A is a schematic view illustrating an electronic device according to an embodiment of the invention. It should be noted that, since the electronic device 100 and the electronic device 102 in FIG. 1 may substantially have similar elements, the elements required by the electronic devices are only described using an electronic device 200 as an example.

Referring to FIG. 2A, the electronic device 200 includes a display 20, a communicator 22, a storage 24, and a processor 26. In addition, the display 20, the communicator 22, and the storage 24 are respectively coupled to the processor 26. The electronic device 200 is a mobile electronic device such as a mobile phone, a tablet computer, a notebook computer, or the like. However, it should be noted that the invention is not limited thereto.

The display 20 may be a display device providing a display function in a display area of the electronic device 200. The display 20 may be a display device capable of providing a display function, such as a liquid crystal display (LCD), a light emitting diode (LED) display, a field emission display (FED) or the like.

The communicator 22 may be an element adapted for signal transmission through the global system for mobile communication (GSM), the personal handy-phone system (PHS), the code division multiple access (CDMA) system, the wideband code division multiple access (WCDMA) system, the long term evolution (LTED) system, the worldwide interoperability for microwave access (WiMAX) system, the wireless fidelity (WiFi) system, or he Bluetooth system.

The storage 24 may be any type of static or mobile random access memory (RAM), read-only memory (ROM), flash memory, similar elements, or a combination thereof.

The processor 26 may be a central processing unit (CPU) or other programmable general-purpose or specific-purpose microprocessors, digital signal processors (DSP), programmable controllers, application specific integrated circuits (ASIC), other similar elements, or a combination thereof.

In the exemplary embodiment, a plurality of programming code segments are stored in the storage 24 of the electronic device 200. After the programming code segments are installed, the processor 26 may execute the programming code segments. For example, the storage 24 includes a plurality of modules. Respective operations of the electronic device 100 for the user location notification system 1000 are respectively carried out through the modules. In addition, the respective modules include one or more programming code segments. However, the invention is not limited thereto. The respective operations of the electronic device 100 may also be implemented in a hardware form.

FIG. 2B is a schematic view illustrating a server according to an embodiment of the invention.

Referring to FIG. 2B, the server 110 includes a communicator 30, a storage 32, and a processor 34. In addition, the communicator 30 and the storage 32 are respectively coupled to the processor 34. The communicator 30, the storage 32, and the processor 34 may be elements respectively similar to the communicator 22, the storage 24, and the processor 26. Thus, details in this regard will not be repeated in the following.

In the exemplary embodiment, a plurality of programming code segments are stored in the storage 32 of the server 110. After the programming code segments are installed, the processor 34 may execute the programming code segments. For example, the storage 32 includes a plurality of modules. Respective operations of the server 110 for the user location notification system 1000 are respectively carried out through the modules. In addition, the respective modules include one or more programming code segments. However, the invention is not limited thereto. The respective operations of the server 110 may also be implemented in a hardware form.

FIG. 2C is a schematic view illustrating a signal transmitting device according to an embodiment of the invention. It should be noted that, since the signal transmitting device 130, the signal transmitting device 132, and the signal transmitting device 134 may substantially have similar elements, the elements required by the electronic devices are only described using a signal transmitting device 220 as an example.

Referring to FIG. 2C, the signal transmitting device 220 includes a signal transmitter 40 and a processor 42. In addition, the signal transmitter 40 is coupled to the processor 42. The processor 42 may be an element similar to the processor 26. Thus, details in this regard will not be repeated in the following.

The signal transmitter 40 may be a transmitter for transmitting a signal. The signal transmitted by the transmitter may include an identification code. The identification code may server to identify an identity of the user possessing the signal transmitting device 220, for example. In the exemplary embodiment, the signal transmitter 40 is a transmitter for transmitting a beacon. However, the invention is not limited thereto. The signal transmitter 40 may also be a signal transmitter transmitting other types of signals.

FIG. 2D is a schematic view illustrating a sensing device according to an embodiment of the invention. It should be noted that, since the sensing device 140 and the sensing device 142 in FIG. 1 may substantially have similar elements, the elements required by the sensing devices are only described using a sensing device 240 as an example.

Referring to FIG. 2D, the sensing device 240 includes a signal receiver 50, a communicator 52, and a processor 54. In addition, the receiver 50 and the communicator 52 are coupled to the processor 54. The communicator 52 and the processor 54 may be elements respectively similar to the communicator 22 and the processor 26. Thus, details in this regard will not be repeated in the following.

The signal receiver 50 may serve to receive (or sense) the signal transmitted by the signal transmitter 40 of the signal transmitting device 220. In the exemplary embodiment, the signal receiver 50 is a signal receiver for receiving the beacon signal, such as a Bluetooth low energy (BLE) bridge configured to combine BLE detection and WiFi communication. However, the invention is not limited thereto. The signal receiver 50 may also be a signal receiver receiving (or sensing) other types of signals.

Referring to FIG. 1 again, in the user location notification system 1000 of the invention, it is assumed that the sensing device 140 is deployed at a gate of a school and the sensing device 142 is disposed at a classroom of the school. The signal transmitting devices 130 to 134 are wore by monitored users (e.g., students), whereas other users (e.g., parents or teachers) may learn locations of the users wearing the signal transmitting devices 130 to 134 through the electronic device 100 or the electronic device 102.

For example, it is assumed that the electronic device 100 is possessed by a parent (also referred to as a second user), whereas the electronic device 102 is possessed by a teacher. The teacher may set data of the student to be monitored via the electronic device 102, for example. For example, the user may set a user record of the student (also referred to as a first user) wearing the signal transmitting device 130 in advance through an application of the electronic device 102. The user record includes a corresponding relation (also referred to as a first relation) between an identification code (also referred to as a first identification code) in a beacon (also referred to as a first signal) transmitted by the signal transmitting device 130 and the student wearing the signal transmitting device 130. The corresponding relation may be a corresponding relation between the identification code of the beacon and a student identity number of the student, for example. However, the invention is not limited thereto. In addition, the teacher may also set a name (also referred to as a first name) and a picture (also referred to as a second picture) of the student wearing the signal transmitting device 130 through the application of the electronic device 102 to store the student's name and picture to the user record. When the setting is finished, the electronic device 102 may transmit a message (also referred to as a second message) to the server 110 to store the user record in the server 110. In addition, user records of the students wearing the signal transmitting device 132 and the signal transmitting device 134 may also be stored in the server 110 in the same way. Thus, details in this regard will not be repeated in the following.

Besides, the teacher may also sets a place record of a place where the sensing device is deployed by using the electronic device 102. For example, the teacher may set a place record (also referred to as a first place record) of the place 10 (also referred to as a first place) where the sensing device 140 is deployed through the application in the electronic device 102. The place record includes a corresponding relation between an identification code (also referred to as a second identification code) of the sensing device 140 (also referred to as a first sensing device) and the place 10. The corresponding relation is also referred to as a second relation. The corresponding relation is a corresponding relation between an identification code (e.g., a device code or an IP address) of the sensing device and a number (or name) of the place 10. However, the invention is not limited thereto. In addition, the teacher may also set a name (also referred to as a second name) and a picture (also referred to as a second picture) of the place 10 through the application of the electronic device 102 to store the name and the picture of the place 10 in the place record. When the setting is finished, the electronic device 102 may transmit a message (also referred to as a third message) to the server 110 to store the place record in the server 110. In addition, a place record of the place 12 may also be stored in the server 110 in the same way. Thus, details in this regard will not be repeated in the following.

Particularly, when a parent intends to learn the student's location by using the electronic device 100, authorization of the parent must be set in advance by the teacher. For example, the teacher may set a user record (also referred to as a second user record) of the parent through the application of the electronic device 102. The user record includes account information, such as an e-mail address, of the parent. In addition, the user record of the parent may further include a corresponding relation between the parent and the student to be monitored (e.g., the student wearing the signal transmitting device 130). When the setting is finished, the electronic device 102 may transmit a message (also referred to as a fourth message) to the server 110 to store the user record in the server 110. Then, the parent may log on with his/her e-mail address and learn the location of the student to be monitored. In other words, through the setting of authorization, the case that an unauthorized user learns the location of the student wearing the signal transmitting device is avoided, and security of the system is thus reinforced.

Besides, when the student wearing the signal transmitting device 130 arrives at the place 10 (e.g., the gate of the school) where the sensing device 140 is deployed, the sensing device 140 may detect a signal (also referred to as a first signal) transmitted by the signal transmitting device 130. The first signal is associated with the student wearing the signal transmitting device 130. In other words, the user record corresponding to the identification code of the first signal can be found in the server 110, and according to the user record, it is learned that the identification code corresponds to the student wearing the signal transmitting device 130.

After detecting the signal transmitted by the signal transmitting device 130, the sensing device 140 may transmit a message (also referred to as a first message). The message may include the identification code in the first signal. After receiving the first message, the server 110 may refer to the identification code of the first signal carried by the first message and the user record, the place record, and the parent's account information (i.e., the e-mail address) stored in the server 110 and transmit a notification message (also referred to as a first notification message) to the electronic device 100. The notification message serves to indicate that the student wearing the signal transmitting device 130 is in a range (also referred to as a first range) adjacent to the gate of the school. In other words, the notification message transmitted by the server 110 serves to notify the parent that the monitored student already arrives at the gate of the school.

Then, the electronic device 100 may receive the notification message transmitted by the server 110 and display information through an application according to the notification message. For example, the application of the electronic device 100 may display a push message according to the notification message from the server 110 to notify the parent with the message that the monitored student (e.g., the student wearing the signal transmitting device 130) already arrives at the gate of the school. Besides, in an exemplary embodiment, the application of the electronic device 100 may also display the name and picture of the monitored student (e.g., the student wearing the signal transmitting device 130), the name of the place 10 and/or the picture of the place 10 according to the notification message from the server 110.

Besides, in an exemplary embodiment, the same parent may also simultaneously monitor a plurality of students at different locations. For example, it is assumed that the parent using the electronic device 100 intends to simultaneously monitor whereabouts of the student wearing the signal transmitting device 130 and the student wearing the signal transmitting device 134 (also referred to as a third user). The parent using the electronic device 100 may learn the information that the student wearing the signal transmitting device 130 already arrives at the place 10 (e.g., the gate of the school) according to the embodiment above. Similarly, when the signal transmitting device 134 (also referred to as a second signal transmitting device) is located at the place 12, the sensing device 142 may also detects a signal (also referred to as a second signal) transmitted by the signal transmitting device 134. The second signal is associated with the student wearing the signal transmitting device 134. In other words, the user record corresponding to the identification code of the second signal can be found in the server 110, and according to the user record, it is learned that the identification code corresponds to the student wearing the signal transmitting device 134.

After detecting the signal transmitted by the signal transmitting device 134, the sensing device 142 may transmit a message (also referred to as a third message) to the server 110. The message may include the identification code in the second signal. After receiving the third message, the server 110 may refer to the identification code of the second signal carried by the third message and the user record, the place record, and the parent's account information (i.e., the e-mail address) stored in the server 110 and transmit a notification message (also referred to as a second notification message) to the electronic device 100. In addition, the notification message serves to indicate that the student wearing the signal transmitting device 134 is in a range (also referred to as a second range) adjacent to a classroom. In other words, the notification transmitted by the server 110 serves to inform the parent that the monitored student is in the classroom where the sensing device 142 is deployed. Accordingly, the parent may simultaneously monitor students at different locations and learn the whereabouts of the students.

It should be noted that, while the embodiment is described with a parent using the electronic device 100 as an example, the invention is not limited thereto. The embodiment that the electronic device 100 receives the notification message of the server 110 may also be applied to the electronic device 102 for the teacher to learn the current locations of all the students wearing the signal transmitting devices. Besides, the teacher may also learn the students wearing the signal transmitting devices in each place, so as to facilitate the efficiency of personnel management.

In particular, in the embodiments of the invention, the teacher may further learn the number of people wearing the signal transmitting devices in a place. Specifically, in FIG. 1, since the signal transmitting device 130 and the signal transmitting device 132 (jointly referred to as first electronic devices) are located in the place 10, the sensing device 140 may simultaneously detect the signals transmitted by the signal transmitting device 130 and the signal transmitting device 132. The sensing device 140 may transmit a message to the server 110 according to the detected signals. Then, the server 110 may transmit a notification message to the electronic device 102 according to the signals detected by the sensing device 140. The notification message includes the number of the signal transmitting devices within the range adjacent to the place 10. Hence, the teacher is able to learn the number of the students in the place 10 by using the electronic device 102, thereby checking the attendance.

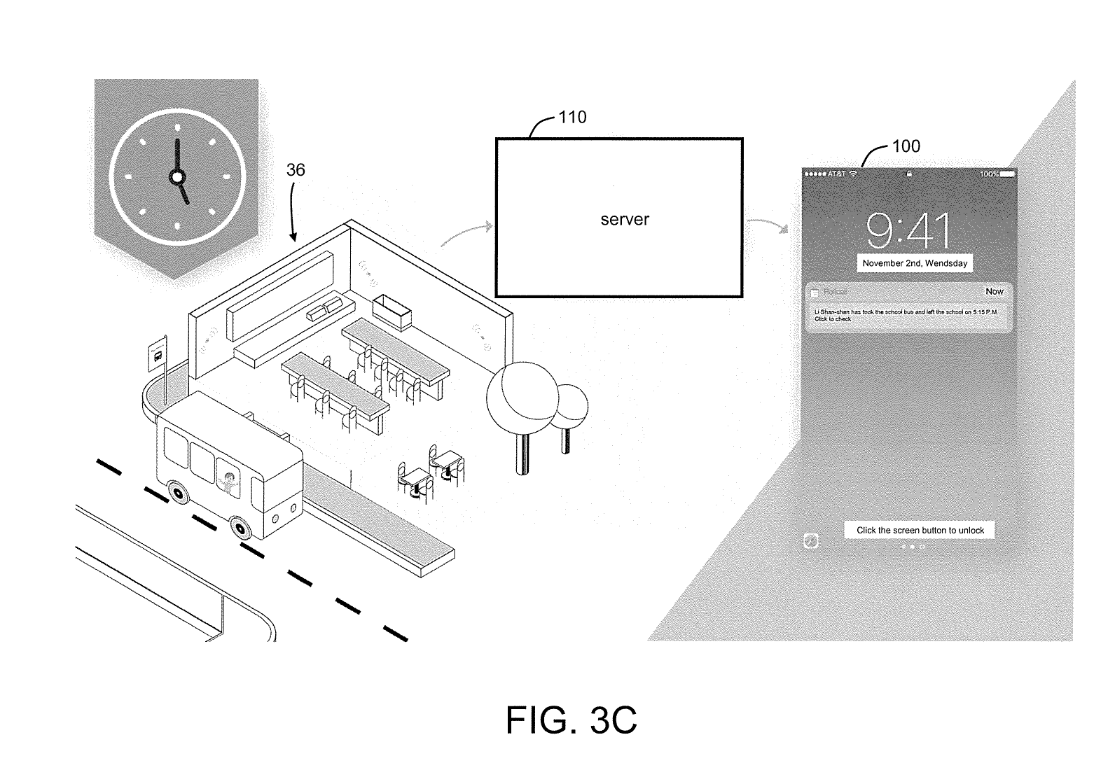

FIGS. 3A to 3C are schematic views illustrating a scenario of using a user location notification system according to an embodiment of the invention.

Referring to FIG. 3A, in the exemplary embodiment, it is assumed that a plurality of the sensing devices as shown in FIG. 2D are deployed in a classroom 30, and all the students in the classroom 30 wear the signal transmitting devices shown in FIG. 2C. The sensing devices in the classroom 30 may detect signals transmitted by the signal transmitting devices wore by the students in the classroom 30. The sensing devices may transmit a message to the server 110 according to the detected signals. Then, the server 110 may transmit a notification message to the electronic device 102 of the user according to the signals detected by the sensing devices. The teacher is thus able to immediately learn the number of students (e.g., five) currently in the classroom 30 and further learns exact identities of the respective students currently in the classroom 30 by clicking a frame.

Referring to FIG. 3B, in the exemplary embodiment, it is assumed that a plurality of the sensing devices as shown in FIG. 2D are deployed in a library 32 and a playground 34, and all the students in the library 32 and the playground 34 wear the signal transmitting devices shown in FIG. 2C. The sensing devices in the library 32 and the playground 34 may detect signals transmitted by the signal transmitting devices wore by the students in the library 32 and the playground 34. The sensing devices may transmit a message to the server 110 according to the detected signals. Then, the server 110 may transmit a notification message to the electronic device 102 of the user according to the signals detected by the sensing devices. The teacher is thus able to immediately learn the numbers of students currently in the library 32 (e.g., five students) and the playground 34 (e.g., two students) and further learn exact identities of the respective students currently in the library 32 and the playground 34 by clicking a frame.

Referring to FIG. 3C, in the exemplary embodiment, it is assumed that the sensing device as shown in FIG. 2D is deployed at a gate 36 of the school, and the students wear the signal transmitting devices shown in FIG. 2C. When classes are over and the students exit the school through the gate, the sensing device at the gate 36 of the school may detect the signals transmitted by the signal transmitting device wore by the students. The sensing devices may transmit a message to the server 110 according to the detected signals. Then, the server 110 may transmit a notification message to the electronic device 100 of the parent according to the signals detected by the sensing devices to display a push message. The parent is thus able to be immediately notified via the electronic device 100 that the monitored student's classes are over and the student already exits the gate of the school.

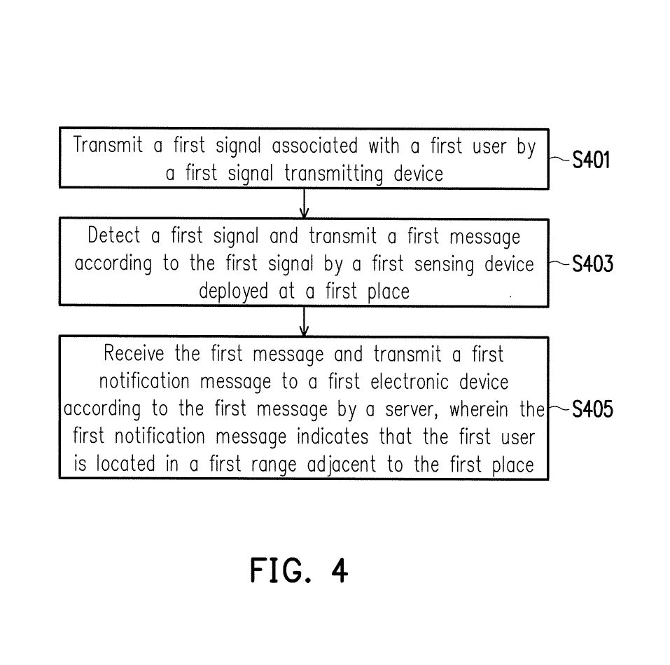

FIG. 4 is a flowchart illustrating a user location notification method according to an embodiment of the invention.

Referring to FIG. 4, at Step S401, a first signal transmitting device transmits a first signal associated with a first user. At Step S403, a first sensing device deployed at a first place detects the first signal and transmits a first message according to the first signal. At Step S405, a server receives the first message and transmits a first notification message to a first electronic device according to the first message. The first notification message indicates that the first user is within a first range adjacent to the first place.

In view of the foregoing, the user location notification system according to the embodiments of the invention allows the parents and the teachers to conveniently learn the current locations and whereabouts of the monitored students in a real-time manner, thereby checking the attendance. Hence, the efficiency of personnel management is reinforced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A user location notification system, comprising:
a first signal transmitting device, transmitting a first signal associated with a first user;
a first sensing device, deployed at a first place, detecting the first signal, and transmitting a first message according to the first signal; and
a server, receiving the first message and transmitting a first notification message to a first electronic device according to the first message, wherein the first notification message indicates that the first user is located in a first range adjacent to the first location.

2. The user location notification system as claimed in claim 1, wherein:
the server stores a first user record and a first place record, the first user record comprises a first corresponding relation between a first identification code in the first signal and the first user, and the first place record comprises a second corresponding relation between a second identification code of the first sensing device and the first place.

3. The user location notification system as claimed in claim 2, wherein in an operation that the server transmits the first notification message to the first electronic device according to the first message,
the server transmits the first notification message to the first electronic device according to the first message, the first user record, and the first place record.

4. The user location notification system as claimed in claim 2, further comprising:
a second electronic device, wherein before an operation that the server receives the first message and transmits the first notification message to the first electronic device according to the first message,
the second electronic device transmits a second message to the server to store the first user record in the server.

5. The user location notification system as claimed in claim 2, further comprising:
a second electronic device, wherein before an operation that the server receives the first message and transmits the first notification message to the first electronic device according to the first message,
the second electronic device transmits a third message to the server to store the first place record in the server.

6. The user location notification system as claimed in claim 2, wherein the first user record comprises a first name and a first picture of the first user, and the first place record comprises a second name and a second picture of the first place.

7. The user location notification system as claimed in claim 6, wherein:
the first electronic device displays at least one of the first name, the first picture, the second name, and the second picture according to the first notification message.

8. The user location notification system as claimed in claim 2, further comprising:
a second electronic device, wherein before an operation that the server receives the first message and transmits the first notification message to the first electronic device according to the first message,
the second electronic device transmits a fourth message to the server to store a second user record in the server, wherein the second user record comprises account information of a second user of the first electronic device.

9. The user location notification system as claimed in claim 8, wherein in an operation that the server transmits the first notification message to the first electronic device,
the server transmits the first notification message to the first electronic device according to the first message and the account information.

10. The user location notification system as claimed in claim 8, wherein the account information is an e-mail address of the second user.

11. The user location notification system as claimed in claim 1, further comprising:
a second signal transmitting device, transmitting a second signal associated with a third user; and
a second sensing device, deployed at a second place, detecting the second signal, and transmitting a third message according to the second signal,
wherein the server receives the third message and transmits a second notification message to the first electronic device according to the third message, and the second notification message indicates that the third user is located in a second range adjacent to the second location.

12. The user location notification system as claimed in claim 1, wherein:
the first electronic device displays a push message according to the first notification message.

13. The user location notification system as claimed in claim 1, wherein the first notification message further indicates the number of the first signal transmitting device in the first range adjacent to the first place.

14. The user location notification system as claimed in claim 1, wherein the first signal associated with the first user is a beacon signal.

15. The user location notification system as claimed in claim 1, wherein the first sensing device is a Bluetooth low energy (BLE) bridge.

16. A user location notification method for a user location notification system, the method comprising:
transmitting a first signal associated with a first user by a first signal transmitting device;
detecting the first signal and transmitting a first message according to the first signal by a first sensing device, wherein the first sensing device is deployed at a first place; and
receiving the first message and transmitting a first notification message to a first electronic device according to the first message by a server, wherein the first notification message indicates that the first user is in a first range adjacent to the first place.

17. The user location notification method as claimed in claim 16, further comprising:
storing a first user record and a first place record by the server, wherein the first user record comprises a first corresponding relation between a first identification code in the first signal and the first user, and the first place record comprises a second corresponding relation between a second identification code of the first sensing device and the first place.

18. The user location notification method as claimed in claim 17, wherein transmitting the first notification message to the first electronic device according to the first message by the server comprises:
transmitting the first notification message to the first electronic device according to the first message, the first user record, and the first place record by the server.

19. The user location notification method as claimed in claim 17, wherein before receiving the first message and transmitting the first notification message to the first electronic device according to the first message by the server comprises:
transmitting a second message to the server by a second electronic device to store the first user record in the server.

20. The user location notification method as claimed in claim 17, wherein before receiving the first message and transmitting the first notification message to the first electronic device according to the first message by the server comprises:
transmitting a third message to the server by a second electronic device to store the first place record in the server.

21. The user location notification method as claimed in claim 17, wherein the first user record comprises a first name and a first picture of the first user, and the first place record comprises a second name and a second picture of the first place.

22. The user location notification method as claimed in claim 21, further comprising:
displaying at least one of the first name, the first picture, the second name, and the second picture according to the first notification message by the first electronic device.

23. The user location notification method as claimed in claim 17, wherein before receiving the first message and transmitting the first notification message to the first electronic device according to the first message by the server comprises:
transmitting a fourth message to the server by the second electronic device to store a second user record in the server, wherein the second user record comprises account information of a second user of the first electronic device.

24. The user location notification method as claimed in claim 23, wherein transmitting the first notification message to the first electronic device by the server comprises:
transmitting the first notification message to the first electronic device by the server according to the first message and the account information.

25. The user location notification method as claimed in claim 23, wherein the account information is an e-mail address of the second user.

26. The user location notification method as claimed in claim 16, further comprising:
transmitting a second signal associated with a third user by a second signal transmitting device;
detecting the second signal and transmitting a third message according to the second signal by a second sensing device, wherein the second sensing device is deployed at a second place; and
receiving the third message and transmitting a second notification message to the first electronic device according to the third message by the server, wherein the second notification message indicates that the third user is located in a second range adjacent to the second location.

27. The user location notification method as claimed in claim 16, further comprising:
displaying a push message according to the first notification message by the first electronic device.

28. The user location notification method as claimed in claim 16, wherein the first notification message further indicates the number of the first signal transmitting device in the first range adjacent to the first place.

29. The user location notification method as claimed in claim 16, wherein the first signal associated with the first user is a beacon signal.

30. The user location notification method as claimed in claim 16, wherein the first sensing device is a Bluetooth low energy (BLE) bridge.
